(19) United States
(12) Patent Application Publication
(10) Pub. No.: US 2009/0185882 A1
(43) Pub. Date: Jul. 23, 2009

(54) PUNCHING DEVICE AND BOOKBINDING DEVICE

(76) Inventor: Kiyoshi HATA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/355,375

(22) Filed: Jan. 16, 2009

(30) Foreign Application Priority Data
Jan. 22, 2008 (JP) JP2008-011236

(51) Int. Cl. B42C 5/04; B26F 1/04; B42C 9/00

(52) U.S. Cl. 412/33; 83/468.1; 83/618; 412/16; 412/37

(57) ABSTRACT

A punching device to form a notch on a sheet by cutting away a portion of a sheet edge, having a punch having a double projection section at an anterior end thereof, wherein the portion of the sheet edge is cut away without apexes of the double projection section coming in contact with the sheet.

This application is based on Japanese Patent Application No. 2008-011236 filed on Jan. 22, 2008 in Japanese Patent Office, the entire content of which is hereby incorporated by reference.

### BACKGROUND OF THE INVENTION

The present invention relates to punching device to form a notch on a sheet edge and a bookbinding apparatus provided with the punching device thereof.

There has been known a bookbinding apparatus in which a sheet conveyance section conveys a sheet sent form an image forming apparatus, the sheet conveyed is stacked to form a sheet bundle, and after applying glue on a spine of the sheet bundle, the spine and a coversheet are adhered to form a booklet (for example, see Patent Document 1: Unexamined Japanese Patent Application Publication No. 2004-209869).

In the booklet formed through such bookbinding apparatus, there has been a problem that some of sheets fall off form the booklet because an adhesive force between the sheets or between the coversheet and the sheets is insufficient due to a small contact area of an edge surface with the glue.

To cope with the above problem, there has been know a technology to increase the adhesive force between the sheets or between the coversheet and the sheets, by increasing the contact area of the edge surface of each sheet with the glue where notches are formed on an edge of the sheet and the sheet having the notches are stacked subsequently. (For example, see Patent Document 2: Unexamined Japanese Patent Application Publication No. 2007-62145)

There are various shapes of the notches formed on the spine of the sheet bundle. In many cases, the notch in a shape of a half circle is formed through a punching device using a punch whose cross-section is in a shape of a circle.

Meanwhile, in offices or workshops related to printing and bookbinding, various types of punching devices are used to form a circle hole for binding at an edge section of the sheet.

In these punching devices, the sheet is placed between a punch and a die, and a circle hole is formed by applying a force onto the punch.

At an anterior end of the punch used for such punching device, for a purpose of forming a fine hole, projection sections (double projection section) are often provided at two portions of the fringe across a center of an end surface so that the displacement of the sheet at initial stage of contact of the anterior end and the sheet is prevented.

However, in case the aforesaid punching device is diverted to form a notch having the shape of half circle at the edge section of the sheet, the notch cannot be formed properly.

The above phenomenon appears particularly when a shallow notch having the shape of half circle is formed at the edge section of the sheet.

Patent Document 1: Unexamined Japanese Patent Application Publication No. 2004-209869

Patent Document 2: Unexamined Japanese Patent Application Publication No. 2007-62145

### SUMMARY OF THE INVENTION

Structure 1. A punching device to cut away the sheet edge through a punch having a double projection section, wherein the sheet edge is cut away without apexes of the double projection section coming in contact with the sheet.

Structure 2. A bookbinding apparatus, having: the punching device of Structure 1; a sheet conveyance section to convey the sheet having been processed by the punching device; a sheet accumulation section to accumulate the sheet conveyed from the sheet conveyance section and form a sheet bundle; a bookbinding processing section to apply glue on a spine of the sheet bundle, formed through the sheet accumulation section, representing the sheet edge whose portion is cut away.

### BRIEF DESCRIPTION OF THE DRAWINGS

FIG. 1 is a schematic diagram of the bookbinding system.

FIG. 2 is a schematic diagram of the image forming apparatus.

FIG. 3 is a block diagram showing control of the bookbinding system.

FIG. 4 is a schematic diagram of a first post-processing apparatus.

FIG. 5 is a side cross-sectional view showing a concept of a punching device.

FIG. 6 is a perspective view of a punching device observed obliquely from a lower side.

FIG. 7 is a schematic diagram of a second post-processing apparatus.

FIGS. 8(a) and (b) are perspective view showing a concept of bookbinding.

FIGS. 9(a) and (b) are views showing an anterior end section of a punch of a punching device.

FIGS. 10(a) and (b) are diagrams describing punching operation through a punch.

FIGS. 11(a) and (b) are examples of notches formed on edges of sheets through a punching device.

FIGS. 12(a) and (b) are diagrams describing a direction of a double projection section of a punch and an edge of a sheet.

FIGS. 13(a) and (b) are diagrams describing a direction of a double projection section of the punch and an edge of a sheet.

### DETAILED DESCRIPTION OF THE PREFERRED EMBODIMENT

An embodiment of the present invention will be described with reference to the drawings.

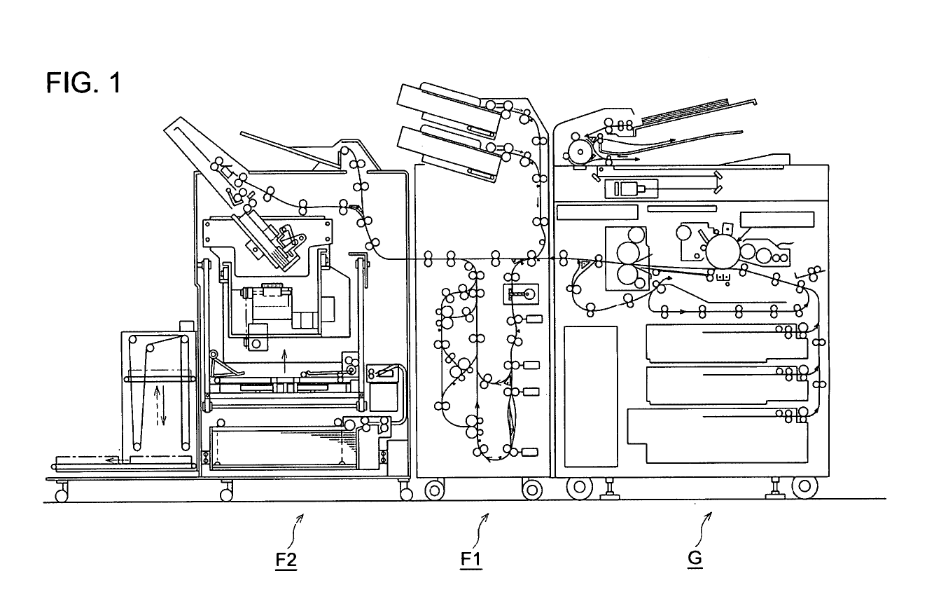

FIG. 1 is a schematic diagram of the book binding system.

The bookbinding system is configured with an image forming apparatus G, a first post-processing apparatus F1, and a second post-processing apparatus F2.

While the image forming apparatus G shown in FIG. 1 forms a monochrome image on a sheet through a publicly known electrophotographic technology, it can be one to form a color image or one utilizing other technology than the electrophotographic technology.

The first post-processing apparatus F1 and the second post-processing apparatus F2 are apparatuses to form a booklet by applying a process, in accordance with specifications of a jog set in advance, on the sheet P conveyed from the image forming apparatus G. The apparatus can be two units such as the embodiment of the present invention or one integrated unit.

In the description of the present invention, an apparatus configured with the first post-processing apparatus F1 and the second post-processing apparatus F2 is called a bookbinding apparatus.

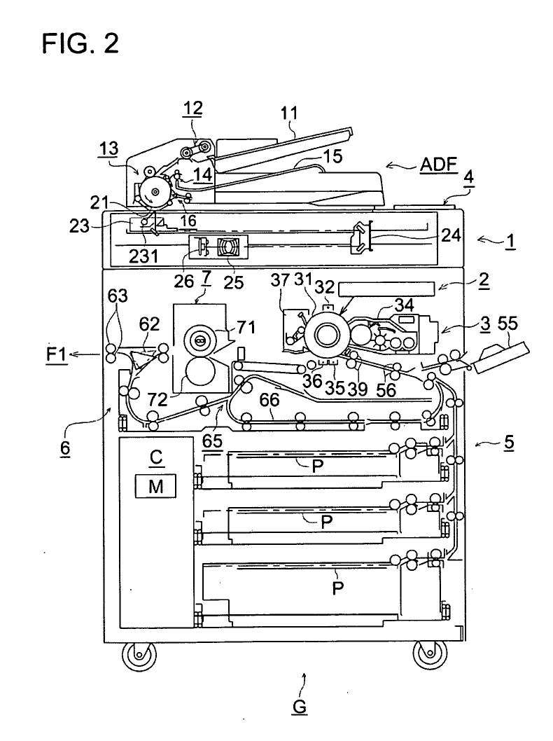

FIG. 2 is a schematic diagram of the image forming apparatus G.

The image forming apparatus G is provided with an automatic document feeding device ADF at an upper part of a main body. The main body is configured with an image reading section 1, an image writing section 2, an image forming section 3, an operation display section 4, a sheet feeding section 5, an ejected sheet re-feeding section 6, a fixing section 7 and a control section C.

The automatic document feeding apparatus ADF sends out the document placed on the document placing table 11 through a document separation section 12 to a document conveyance section 13 one by one then the document conveyance section 13 conveys the sent document to a document sheet ejection section 14 and the document sheet ejection section 14 ejects the conveyed sheet to the document sheet ejection table 15. A document image is read through a slit 21 representing a document image reading position of-an image reading section 1 provided at a document conveyance path.

To read images on both surfaces, a document reversal section 16 having a pair of rollers turns over the document of which a first surface has been read then the sheet is fed to the document conveyance section 13 again to read an image on the second surface. The sheet having been read is ejected to the document sheet ejection table 15.

The image reading section 1 is a device to obtain image data by reading the document image, wherein a document image irradiated by a lamp 231 at a position of the slit 21 forms an image on a CCD representing an imaging element 26 in a shape of a line through a first mirror unit 23, a second mirror unit 24 and an imaging lens 25.

A signal outputted form the imaging element 26, is subject to A/D conversion at an image processing section of the control section c, and subject to processing such as shading correction and image compression then stored in a memory M as image data.

The image reading section 2 is configured with a semiconductor laser, a polygon mirror and a cylindrical lens to scan a surface of the photoconductive substance 31 using a laser beam which is a publicly-know technology.

Output control of the laser beam is carried out based on the image data which is called up from the memory C of the control section C and processed by a predetermined image processing.

A charging device 32 charges a circumferential surface of the photoconductive substance 31 evenly through corona discharging. The circumferential surface of rotating photoconductive substance 31 is optically scanned through the aforesaid laser beam to form an electro latent image, corresponding to the document image, on the circumferential surface of the photoconductive substance 31.

The aforesaid electro latent image is developed reversewise through a developing section 34 of the image forming section 3 to form a toner image on the photoconductive substance 31.

A sheet P is fed from a manual sheet feeding section 55 or a sheet feeding section 5 having a cassette or a tray to store the sheet P and conveyed through conveyance rollers 56 and then synchronized with the toner image formed on the photoconductive substance through timing rollers 39 for positioning with the toner image formed on the photoconductive substance, thereafter sent out to a transfer area.

In the transfer area, the toner image formed on the surface of the photoconductive substance 31 is transferred onto the sheet P having been charged to be an opposite polarity through transfer section 35.

The sheet P carrying the toner image is separated from the surface of the photoconductive substance 31 through a function of the separation discharging section 36 and sent to a fixing section 7.

In the fixing section 7, the aforesaid sheet P carrying the toner image is conveyed while receiving pressure and heat through a heating roller 71 and a pressure roller 72 so as to fix the toner image onto the sheet P, and sent out to the first post-processing apparatus F1 through ejection rollers 63.

Meanwhile, in case the sheet P is turned over and sent out to the first post-processing apparatus, the sheet P is led through a switching guide 62 to be ejected sheet re-feeding section 6 and switched back to be sent to the ejection rollers 63.

Also, in case the images are formed on both surfaces of the sheet P, the sheet P whose first surface is fixed is led to the ejected sheet re-feeding section 6 through the switching guide 62, then after being turned over through the turnover section 65, the sheet P is sent out to the conveyance path 66 for re-feeding and is served for image forming on the second surface.

On the other hand, on the surface of the photoconductive substance after completion of transfer of the toner image onto the sheet P, residual toner is removed by a cleaning section 37 and arrangement for subsequent image forming is prepared.

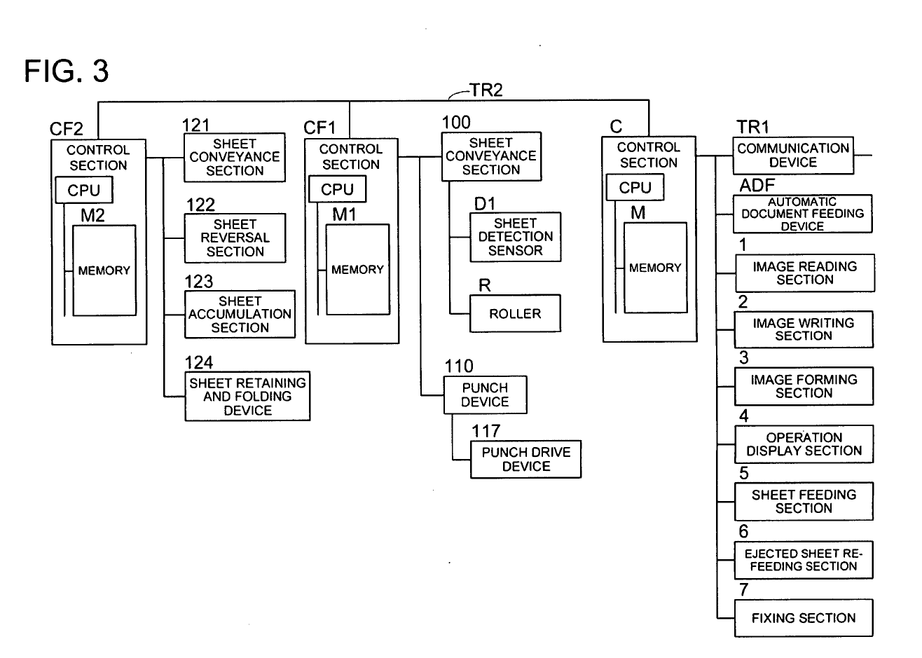

FIG. 3 is a block diagram indicating a control of the bookbinding system.

A control section C of the image forming apparatus, a control section CF1 of the first post-processing apparatus, a control section CF2 of the second post-processing apparatus, are computer systems each having a CPU, a memory, a calculation unit, an I/O port, a communication interface and a drive circuit.

Control of the above control sections is realized by executing predetermined programs stored in memories M, M1 and M2 provided in respective control sections.

The control section C of the image forming apparatus G is connected with an external information processing apparatus through a communication device TR1, also connected with each of the aforesaid control section via a communication device TR2 so as to enable exchanging information.

Meanwhile, in the present figure, portions not related to the description directly are omitted.

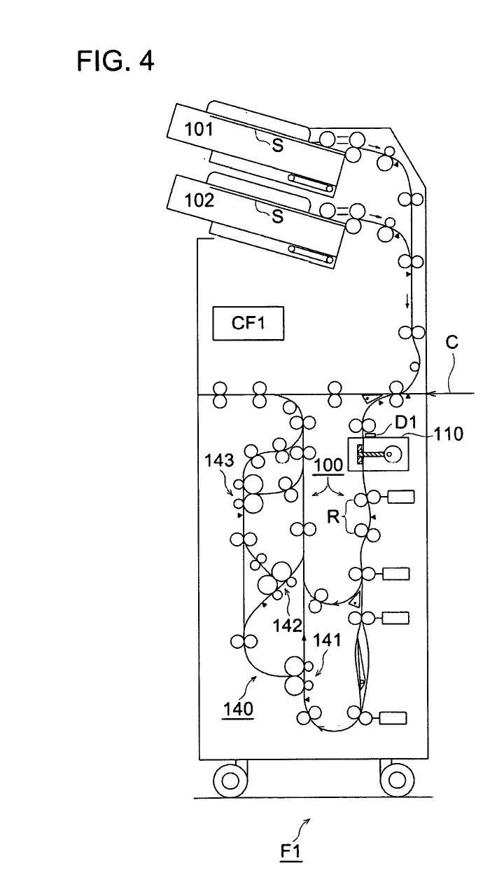

FIG. 4 is a schematic diagram of a first post-processing apparatus F1.

The first post-processing apparatus F1 carries out punching processing, notch forming processing and folding processing on the sheet P conveyed from a direction C of an arrow in the figure or the sheet S conveyed from the sheet tray 101 or 102 at upper part.

Whether or not the above processing is carried out is determined by the setting contents of job setting carried out in advance.

The first post-processing apparatus F1 is equipped with a sheet conveyance section 100 configured with a plurality of curves and rollers in the figure so as to convey the sheet P in order to be adapted to the aforesaid processing.

The punching device 110 to carry out punching processing or notch forming (cut away) processing on the sheet P or the sheet S are disposed in a middle of the conveyance path of the sheet conveyance section 100 carries out predetermined processing on the sheet S or the sheet P stopping at a predetermined position.

A publicly known technology can be utilized as a technology to stop the sheet P or the sheet S at the predetermined position in respect to the punching device 110.

For example, the above operation is realized by controlling timing to stop rotation of the conveyance rollers through the control section CF1 based on a detected signal of the sheet detection sensor D1 to detect an rear edge of the sheet.

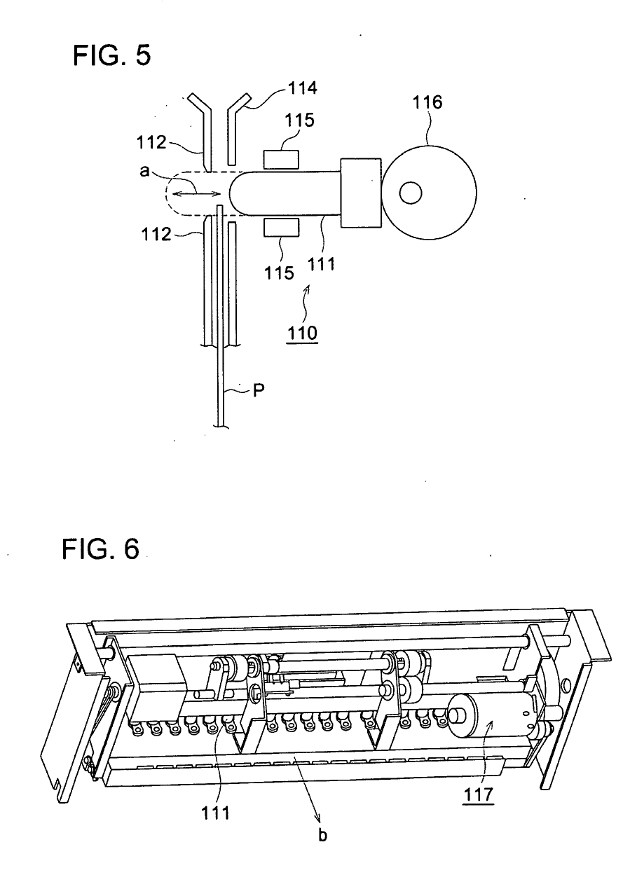

FIG. 5 is a side cross-sectional view to describe an outline of a punching device 110.

In the punching device, the sheet P moves through between a die 112 and a guide plate 114 and stops at the predetermined position, then the punch 111 having double projections protrudes to from a hole at the edge section of the sheet P or a notch in the shape of a half circle at the edge of the sheet P.

The change between hole forming processing and notch forming (cut away) processing is carried out by varying a stopping position of the rear edge of sheet P. Also the depth of the notch in a sheet surface direction can be adjusted by varying the stopping position of the rear edge of the sheet P.

The moving direction of the punch 111 is defined by a guide member 115 and the punch 111 is reciprocated as an arrow a shows through rotation of an eccentric cam 116.

FIG. 6 is a perspective view of the punching device 110 observed obliquely from the lower side.

A front edge of the sheet P having passed through between the die 112 and the guide plate 114 in FIG. 5 pursues in an arrow b direction. A plurality of the punches 111 are arrayed in a raw in a direction perpendicular to the traveling direction of the sheet P and are reciprocated through a punch drive device 117 which drives the plurality of punches simultaneously.

The sheet P or sheet S sent form the punching device 110 are subject to folding processing at the folding processing section as FIG. 4 shows.

The folding processing section 140 is configured with a first folding section 141, a second folding section 142 and a third folding section 143. The sheet P or the sheet S sent from the punching device 110 is subject to folding processing such as middle folding, Z-folding, tri-folding, quarto folding or double parallel folding through the aforesaid three folding sections.

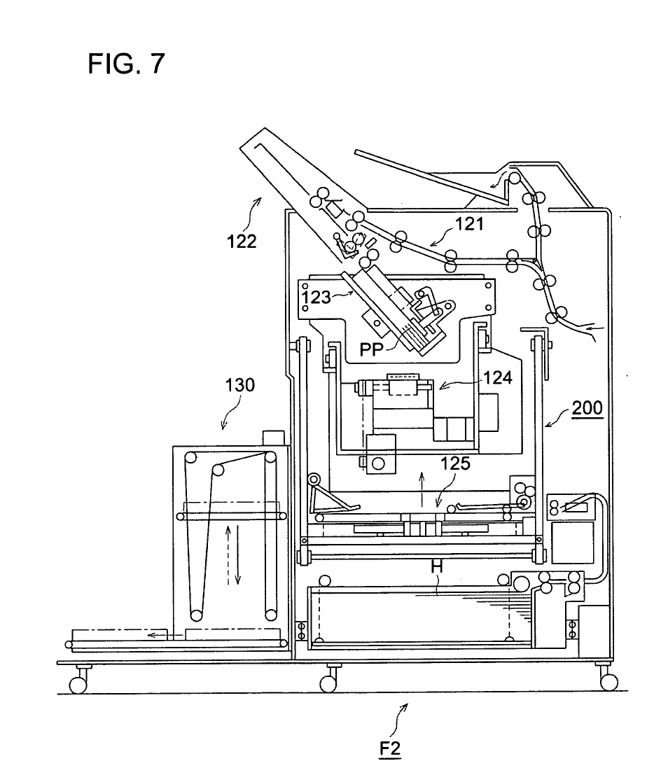

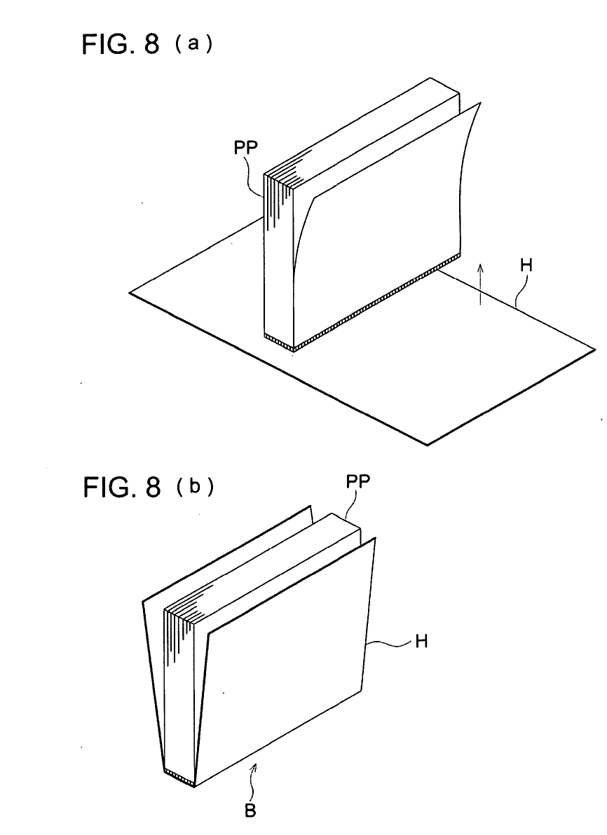

FIG. 7 is a schematic diagram of the second post-processing apparatus F2. FIG. 8 is a diagram to describe a concept of bookbinding.

The second post-processing apparatus F2 forms a sheet bundle PP by accumulating the sheets P or sheets S sent from the first post-binding apparatus F1 and adheres a coversheet on the sheet bundle PP having been formed to form a booklet.

The sheets P or sheets S sent from the first post-processing apparatus F1 are conveyed to a sheet reversal section 122 along a sheet conveyance section 121, then subject to switch-back in the sheet reversal section 122, thereafter accumulated in a sheet accumulation section 123 one by one until a predetermined number of the sheets is accomplished.

When the number of the sheets accumulated reaches at the predetermined number and the sheet bundle PP is formed, the sheet bundle PP is grasped then the sheet accumulation section 123 rotates to hold the sheet bundle PP in a substantially vertical state.

Then the sheet bundle PP is subject to a bookbinding process through a bookbinding processing section 200 equipped with a glue application device 124 and a coversheet folding and adhering device 125.

As FIG. 8(a) shows, in the bookbinding processing section 200, glue is applied on a spine of the sheet bundle PP held in the substantially vertical state.

Application of the glue is carried out by moving an application roller whose part is dipped in glue in a glue container along the spine of the sheet bundle PP (for example, Patent Document 1: Unexamined Japanese Patent Application Publication No. 2004-209869).

After application of the glue is completed, a coversheet H held by the coversheet folding and adhering device 125 is ascended and adhered onto the spine of the sheet bundle PP.

Next, as FIG. 8(b) shows, the coversheet H adhered onto the spine of the sheet bundle PP is folded along the sheet bundle PP to accomplish a booklet.

The booklet B accomplished is ejected to a booklet ejection section 130.

The present invention is related to a punching device equipped with a punch having two projections (double projection section) facing one another at an anterior end section, and a bookbinding apparatus having the punching device thereof.

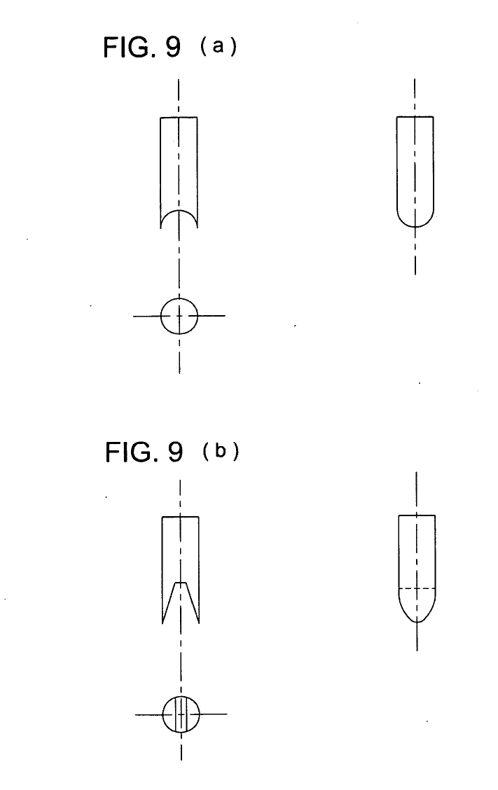

FIG. 9 is a view showing the anterior end section of the punch 111 of the punching device 110.

FIG. 9(a) shows an anterior end section of the punch in a shape of a circular cylinder where the anterior end section is cut away in a shape of a circle arc groove perpendicular to an axis of the punch. FIG. 9(b) shows an anterior end section of the punch in a shape of a circular cylinder where the anterior end section is cut in a trapezoidal shaped groove perpendicular to the axis of the punch.

The above formed shapes of the anterior end sections are varied with the purpose of the punch and typical examples are shown in the figures.

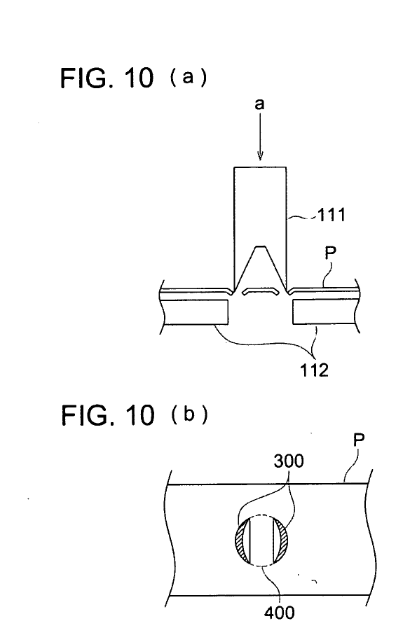

FIGS. 10(a) and (b) describe forming holes through the punch.

A punch 111 in the figure has a double projection section shown in FIG. 9(b) wherein the anterior end section is cut away in the trapezoidal shape.

FIG. 10(a) shows a state where the punch 111 descended in a direction shown by an arrow a, and the anterior end of the punch has penetrated a portion of the sheet P. FIG. 10(b) shows a shape of a hole 300 (hatching section) formed on the sheet P penetrated by the anterior end section of the punch 111.

With further descent of the punch 111, a circular hole 400 is formed on the sheet P and punched sheet scrapes in the circular shape from the sheet P falls downward.

In such punching hole process the double projection section provided at the anterior end of the punch 111 prevents the sheet P from displacing since the sharp two apexes 118 of the double projection section contacts with the sheet P first, therefore a small hole can be formed readily.

Thereafter, along with descending of the punch 111, a circular hole is cut out readily by a shearing force applied at edge sections of the small hole formed with a side rim of the anterior end section of the punch 111 and a die 112.

Providing the double projection section has been known as an effective technology, since the force applied to the punch 111 for forming hole can be reduced and a smooth cutting edge of the hole is realized.

Since the aforesaid punch having the double projection section is widely used for punching devices to form a circular hole on the sheet P, such punch is used for forming the notch in the shape of the half circle on the edge of the sheet P.

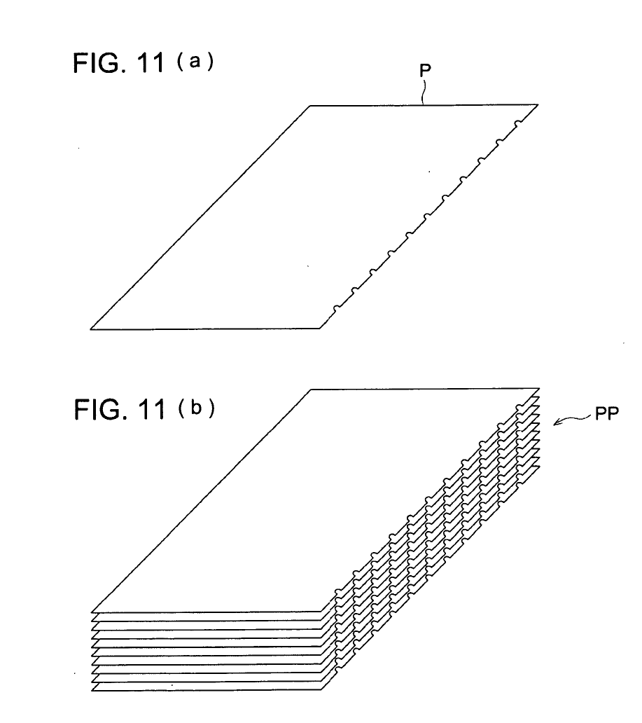

FIGS. 11(a) and (b) show an example of the notches formed on the sheet edge through the punch.

FIG. 11(a) shows a piece of sheet P on which the notches are formed on the edge, and FIG. 11(b) shows a sheet bundle PP formed by accumulating above sheets P.

Meanwhile, when the above notch in the shape of the half circle is formed through the punch having the double projection, some times the desired notch cannot be formed. Such problem tends to occur particularly when the notch in a shape of a shallow half circle is formed.

A cause of the problem is presumed such that different form the case of forming a circular hole on edge section of the sheet P, the double projection section of the punch coming down to the edge of the sheet P does not contact with the sheet P at the same time and only one projection contact with the sheet therefore the edge of the sheet P is displaced.

Namely, it is presumed that the small holes described in FIGS. 10(a) and (b) are not formed on the sheet P through the projections of the punch, thus the sharing force triggered by the edge section of the hole formed cannot be applied.

According to the punching device of the present embodiment, the desired notch in the shape of the half circle can be formed on the edge of the sheet P using the punch having the double projection section.

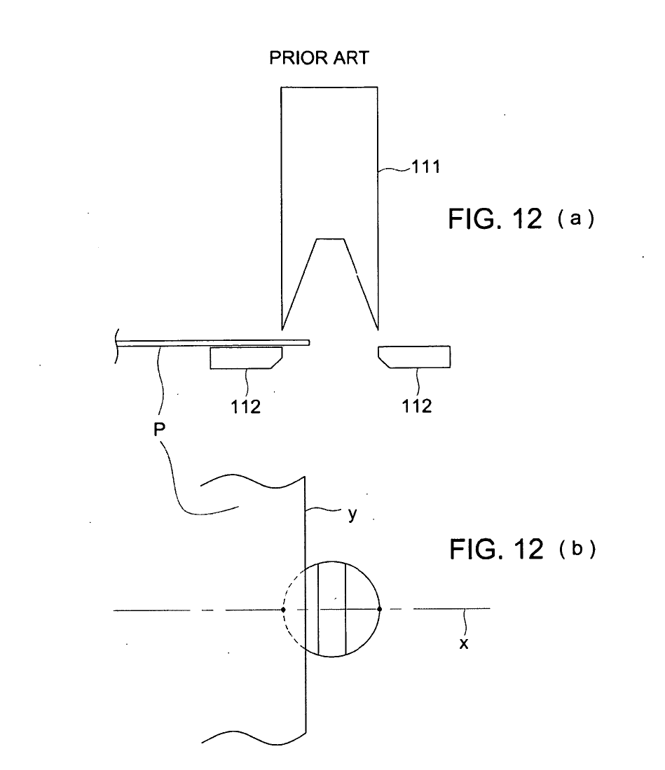

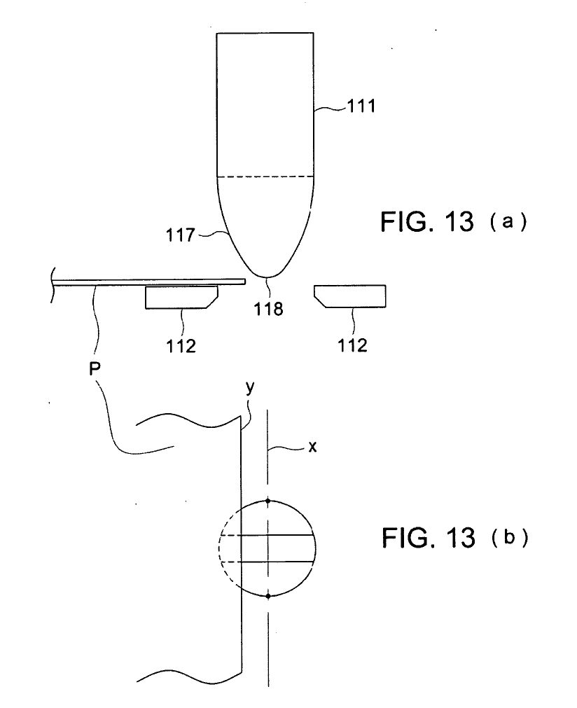

FIG. 12(a), FIG. 12(b), FIG. 13(a) and FIG. 13(b) show the double projection section of the punch and a direction of the sheet edge.

FIG. 12(a) and FIG. 13(a) are side views showing positional relation among the punch 111, sheet P and die 112, and FIG. 12(b) and FIG. 13(b) are views observing from a lower side. Meanwhile, in FIGS. 12(b) and 12(b), the die 112 is omitted to avoid complication of the figures.

As FIG. 12(b) shows, a line x connecting the apexes 118 of the projections of the punch 111 and an edge y of the sheet P are perpendicular one another.

On the other hand, in FIG. 13, the line x connecting the apexes 118 of the projections of the punch 111 and edge y of the sheet P are parallel one another.

If the direction of the double projection section of the punch is disposed as FIG. 12 shows, in notch forming operation, a surface of the edge of the sheet P contacts with the apex 118 of the projection of the punch 111 first. When this occurs, the holes formed through the apex 118 of the punch are not formed on the surface of the edge of the sheet P, and the sheet P is displaced.

In this case, since the edges of the hole to be a trigger for shearing the sheet P is not formed, the desired notch in the shape of the half circle does not tend to be formed.

However, in case the direction of the double projection section of the punch is arranged as in FIG. 13, in the notch forming operation, shoulders 117 of the projection sections of the punch 111 contact the edge of the sheet P first.

Thus, a cut to be a trigger to form the notch on the sheet edge is easily formed through the shearing force applied on the edge of the sheet P, thus the notch in the shape of the half circle is readily formed on the edge of the sheet P.

Through the punch arranged in the above direction, the desired notch in the shape of half circle can be formed on the edge of the sheet P.

Therefore, in bookbinding where the booklet is formed by stacking the sheets subsequently and by applying a glue on the spin of the formed sheet bundle, the contact area of the edge of each sheet with glue can be adjusted by the depth of the notch, as a result, there is realized a bookbinding apparatus capable of obtaining a desirable strength of a adhesion force between the sheets or between the coversheet and the sheets.

Meanwhile, while FIG. 13 shows an example, where the line x connecting the apexes 118 of the double projection section of the punch 111 and the edge of y of the sheet P are in a parallel relation, the same effect can be obtained in a way that the apex 118 of the projection section of the punch does not contact with the sheet P first.

However, the example shown in FIGS. 13(a) and (b) is a preferable arrangement which can maximize the adjustment tolerance in a depth of the notch in the shape of the half circle while realizing the above effect.

What is claimed is:

1. A punching device to form a notch on a sheet by cutting away a portion of a sheet edge, comprising:
a punch having a double projection section at an anterior end thereof;
wherein the portion of the sheet edge is cut away without apexes of the double projection section coming in contact with the sheet.

2. The punching device of claim 1, wherein the punch is disposed in a way that a line connecting two apexes of the double projection section is substantially parallel to the sheet edge whose portion is cut away through the punch.

3. The punching device of claim 1, where the portion of the sheet edge is cut way in a shape of a half circle.

4. A bookbinding apparatus, comprising:
the punching device of claim 1;
a sheet conveyance section to convey the sheet having been processed by the punching device;
a sheet accumulation section to accumulate the sheet conveyed from the sheet conveyance section and to form a sheet bundle;
a bookbinding processing section to carry out bookbinding by applying glue on a spine of the sheet bundle formed through the sheet accumulation section, wherein the spine represents a sheet bundle edge whose portion is cut away.

5. The bookbinding apparatus of claim 4, wherein whether a punching process to form a circular hole at an edge section of the sheet or a cut away process to cut away the sheet edge can be alternatively selected.
